(19) United States
(12) Patent Application Publication
(10) Pub. No.: US 2025/0096642 A1
(43) Pub. Date: Mar. 20, 2025

(54) ELECTRICAL ENERGY GENERATION APPARATUS BASED ON THE PRINCIPLES OF THE DOUBLE PENDULUM

(71) Applicant: Jose Alfonso Iracheta Carroll, Mexico City (MX)

(72) Inventor: Jose Alfonso Iracheta Carroll, Mexico City (MX)

(21) Appl. No.: 18/965,695

(22) Filed: Dec. 2, 2024

(51) Int. Cl. H02K 7/18; F03G 3/06; H02K 7/116

(52) U.S. Cl. CPC H02K 7/1853; F03G 3/06; H02K 7/116

(57) ABSTRACT

This apparatus uses a system of double pendulums that harnesses the gravitational force to generate electricity. The double pendulum system's oscillation is controlled by a swing control gear, which optimizes the resulting kinetic force. The kinetic force is such that allows the double pendulum to return to its original position above its axis, but also to generate excess energy that is recovered through a gearing cassette and a ratchet, and transmitted as torque to the drive shaft. The drive shaft rotates at a speed of between 25 and 35 rpm. Subsequently, it engages two gearboxes that multiplies the rpm by 100 times each, reaching a rotational speed of between 2,500 and 3,500 rpm. The drive shaft enters the power generator and engages a stator that, by rotating, produces an electric current.

### CROSS-REFERENCE TO RELATED APPLICATIONS

### Not Applicable.

### STATEMENT OF FEDERALLY SPONSORED RESEARCH OR DEVELOPMENT

This invention was not made with federal sponsorship or under a federally sponsored project. No federal funds were utilized in the conception, development, or realization of this invention.

The inventor affirms that he has not received any federal funding, grants, or other support for the research, development, or commercialization of this invention.

The invention disclosed herein is independent of any federally sponsored research program or project. The inventor acknowledges that he has not relied on any federally funded facilities, equipment, or personnel in the creation or advancement of this invention.

Any statements made herein regarding federal sponsorship or support are expressly disclaimed.

### NAMES OF THE PARTIES TO A JOINT RESEARCH AGREEMENT

Not Applicable.

### REFERENCE TO A SEQUENCE LISTING

Not Applicable.

### BACKGROUND ON THE INVENTION

This invention pertains to the field of renewable power generation, which is the energy that “comes from unlimited, naturally replenished resources”¹ in this case being the gravitational force.

This invention came to fruition as the result of a process of analysis of the commercially available alternatives for energy production in the context of global climate change, and the global effort to reduce, neutralize and, eventually, eliminate greenhouse gas (GHG) emissions by the energy sector. Even though there have been impressive advances in the technology for producing energy dependent on sources different than the traditional fossil, nuclear, geothermal, and hydraulic, such as solar radiation (light and heat), wind, and marine energy; there is still room for other potential sources of energy that have not been developed so far.

The most relevant of those is the gravitational force, which possesses several advantages in comparison with any other energy source. Gravitational force is free, unlimited, and universally available. Gravitational force does not change, or at least not in a meaningful way²; thus, being stable, continuous, and reliable. Gravitational force remains constant regardless of the time of day and year, weather conditions, altitude and latitude; and therefore, it has the potential for being the most relevant energy source, if there were a technology capable of harnessing it. ¹ U.S. Department of Energy, Office of Energy Efficiency and Renewable Energy, 2024. Available at: https://www.energy.gov/eere/renewable-energy² National Aeronautics and Space Administration (NASA) Earth Data, 2005. Available at: https://www.earthdata.nasa.gov/learn/sensing-our-planet/matter-in-motion-earths-changing-gravity

Each energy source has its strengths and weaknesses. Fossil fuels, which are the most widely used energy source, is highly versatile and the infrastructure for its use is widely available across cities, regions, and countries, accounting for up to 82% of the world's energy.³ However, it is also one of the main sources of emissions of greenhouse gases (GHG), in addition to several polluting components.⁴ The main goal of most countries, including the US, for addressing the causes and consequences of the global climate change is to eliminate burning of fossil fuels, and therefore there are many policies in place globally to shift energy production to non-fossil fuels, as well as to electrify the entire automotive industry.⁵ ³ Energy Institute, 2023. Available at: https://www.energyinst.org/exploring-energy/resources/news-centre/media-releases/ei-statistical-review-of-world-energy-energy-system-struggles-in-face-of-geopolitical-and-environmental-crises⁴ Environmental Protection Agency (EPA), 2024. Available at: https://www.epa.gov/ghgemissions/sources-greenhouse-gas-emissions⁵ The United Nations Framework Convention on Climate Change (UNFCC), 2023. Available at: https://unfccc.int/news/cop28-agreement-signals-beginning-of-the-end-of-the-fossil-fuel-era

Nuclear energy is another available source of energy, different than fossil fuels, since it is generally considered a clean source.⁶ Nuclear energy has many advantages, being the main one its capacity for producing proportionally large amounts of energy in relation with the amount of source material (uranium and thorium) required for such production. On the flipside, nuclear energy faces many shortcomings. One is related to the waste that is generated during the process of energy production, which requires highly specialized handling and it may turn out to be highly problematic when it is not properly done.⁷ A second disadvantage is its relative vulnerability, as the 2011 Fukushima nuclear accident in Japan showed, since the consequences of a nuclear power malfunction have the potential to be catastrophic on a regional and global scale, as opposed to all of the other sources of energy. Another vulnerability of this type of power is the relatively reduced number of nuclear facilities that produce vast amounts of power, in the sense that one incident or failure would have a proportionally larger effect over the grid than other sources of energy. ⁶ U.S. Department of Energy, Office of Nuclear Energy, 2022. Available at: https://www.energy.gov/ne/articles/3-reasons-why-nuclear-clean-and-sustainable⁷ World Nuclear Association, 2022. Available at: https://world-nuclear.org/information-library/nuclear-fuel-cycle/nuclear-wastes/radioactive-waste-management.aspx

Geothermal and hydraulic energy sources are also widely used and both sources are considered clean. Geothermal is an interesting source since it is highly reliable; however, its main drawback is that it can only be used in specific and highly scarce locations, thus reducing its potential.⁸ Hydraulic energy can be harnessed in many more places; however, it is dependent on the flow of water which can be highly unreliable, particularly given the effects of global climate change which has produced droughts in many places of the world. Some studies have showed that, even though the hydropower system in the United States has remained at about 80% of its capacity, the drought, especially in the west, remains a relevant concern.⁹ ⁸ U.S. Department of Energy, Office of Energy Efficiency and Renewable Energy, 2024. Available at: https://www.energy.gov/eere/geothermal/geothermal-faqs⁹ U.S. Department of Energy, Office of Energy Efficiency and Renewable Energy, 2024. Available at: https://www.energy.gov/eere/water/articles/study-finds-hydropower-provides-reliable-electricity-even-during-historic

Finally, the latest technologies for energy production, which are considered “green” sources depend on the sun, the wind and the oceans. The two former sources are driving the global energy transition from fossil fuels to clean sources since they are highly versatile.¹⁰ Particularly the technologies that harness the energy of the sun, mainly the light, can be used at a very small scale, allowing for home-scale energy production; but it can also be scaled up to large sun farms for mass energy production. The main drawback of this source is that the energy generation occurs only during the hours of the day in which there is sun radiation. In its turn, such radiation is also affected by the latitude, time of year and weather conditions. Therefore, even though the sun energy is the most abundant of all, its harnessing potential is restricted, and it requires proportionally larger surfaces for energy generation, reducing further its potential. Wind energy is, as of today, the one with the lowest production costs of the “green” sources, being surpassed by nuclear power only. These production costs are its main advantage, since current technologies are able to harness the wind power in a highly efficient way.¹¹ The main drawbacks of wind energy are two. The first one is that it depends on the flow of wind, which can significantly vary given specific weather and geographic conditions. Such feature reduces the potential for its use, since not all places and not all weather conditions are adequate for harnessing this energy source. The second one is the large size of windmills and the relatively large amounts of land that are required for their operation, which have caused many conflicts between utility companies and land owners across the world. Finally, marine energy, which depends on the force produced by moving water in the form of waves, tides, currents, and differences in water temperature, has been used with very positive results, since marine energy tends to be more stable and reliable than sun and wind.¹² However, the potential for harnessing this source of energy is reduced due to the relatively high costs of its infrastructure and because it can only be used for providing power in coastal areas at an acceptable cost. ¹⁰ International Energy Agency, 2023. Available at: https://www.iea.org/news/rapid-progress-of-key-clean-energy-technologies-shows-the-new-energy-economy-is-emerging-faster-than-many-think¹¹ U.S. Department of Energy, Office of Energy Efficiency and Renewable Energy, 2024. Available at: https://www.energy.gov/eere/wind/advantages-and-challenges-wind-energy¹² U.S. Department of Energy, Office of Energy Efficiency and Renewable Energy, 2024. Available at: https://www.energy.gov/eere/water/advantages-marine-energy

Two additional issues need to be addressed. The first one is about the energy generation and the structure of the distribution grid, which rely on large generation facilities, that produce large amounts of energy for homes, industry and public services. Even though this infrastructure has served well over the decades, it has been acknowledged its relative vulnerability, since one failure would have an effect over large portions of the grid, putting pressure over other facilities and portions of the grid, thus potentially amplifying its negative effects. The 2021 Texas power crisis is a good example of these vulnerabilities. One of the strengths of the more recent “green” alternatives, particularly those that harness the energy of the sun, is that they allow to have the so-called distributed generation, which means that a multiplicity of small-scale solutions may reduce the overall pressure of the grid, reducing the negative effects of isolated failures.

The second issue, which is specific to the “green” sources, relates to their generation variability, since it makes necessary to have back-up systems, usually in the form of batteries that store the energy in order to make it available during the times when there is no power generation. This issue has become a problem for two reasons. The first one is that the production of the most common form of batteries, requires the use of minerals that are relatively rare, such as lithium, cobalt, zinc, or cadmium, among others. The control of these minerals' deposits has become an issue of geo-political concerns, and has put a lot of pressure on mining operations in order to produce enough minerals to satisfy the industry's demand which, in turn, is becoming a source of local and regional conflicts, with a strong potential for affecting local communities, as well as producing environmental damage.¹³ The scarcity of these minerals is the main obstacle and source of uncertainty for the possibility of an overarching energy transition. The second reason is that battery production remains relatively expensive when compared with the generation infrastructure, and this further reduces the potential for a complete and rapid transition. ¹³ Nature, 2021. Available at: https://www.nature.com/articles/d41586-021-01735-z

There are various applications based on the movement of a double pendulum to generate electrical energy. AnonYmousEngineering¹⁴ developed a system where the continuous movement of the double pendulum produces a force vector that is transmitted to the axis to which the double pendulum is attached. The force generates a torque on the shaft which, in turn, is attached to a fixed bar that generates an oscillating movement that moves a magnet inside a coil, generating the flow of electrical energy. ¹⁴ Ymous, Anon, 2013. Available at: https://www.veljkomilkovic.com/Docs/Double_Pendulum_Power.pdf

Another application of a pendulum to generate electrical energy corresponds to a pendulum-lever system developed by Veljko Milkovic. This system takes advantage of the pendulum movement to drive a mechanical lever that is used to generate electrical energy.

In addition to the mentioned applications, 13 patents were identified that use the physical principles of the pendulum to generate electrical energy. While most are based on a simple pendulum, some applications do consider double pendulum principles, where the energy transmission mechanism is through the torque of the axis of said pendulum. Below are the identified patents that are related to electrical generation through the use of pendulums or double pendulums:

| Pat. No. | Date | Patent owner | Description |
|---|---|---|---|
| US | 2018 Oct. 4 | GRANGER; | Two synchronized pendulums with two |
| 20180283364 | | Maurice | perimeter elements that move in |
| A1 | | | opposite directions generating a torque |
| | | | to the axis of the pendulum, which is |
| | | | used to generate electrical energy. |
| US | 2018 Jul. 12 | Ruijssenaars; | An inverted pendulum that generates |
| 20180195492 | | Janjaap | electrical energy when it oscillates |
| A1 | | Holterman; | thanks to the force of gravity, |
| | | Jan | accompanied by a spring that makes |
| | | De Vries; | the pendulum return to its original |
| | | Theodorus | position, above its axis in a neutral |
| | | Jacobus | position. |
| | | Adrianus | |
| US | 2017 Mar. 9 | Karpelson; | A double pendulum whose rotation |
| 20170069823 | | Michael | relative to the structure on which it is |
| A1 | | | placed generates a flow of energy that |
| | | | is stored or recovered. |
| U.S. Pat. No. | 2016 Dec. 13 | Xu; Patrick | A pendulum that rotates in the opposite |
| 9,520,758 | | Zhu; Run De | direction to its containing structure, with |
| B1 | | Liu; Yu Qing | a piece that pushes a rotating system |
| | | Hu; Ethan | that generates electricity. |
| | | Cai; Bocheng | |
| US | 2014 Jul. 3 | Valderrama; | A pendulum that supplements the |
| 20140183874 | | Pedro Enrique | energy to keep it swinging with a spring, |
| A1 | | Viera; Carlos | and generates torque to a rotor that |
| | | Eduardo | generates electricity. |
| US | 2013 Aug. 15 | Eichhorn; | A pendulum that generates torque on its |
| 20130207403 | | Karl | axis to generate electricity. |
| A1 | | | |
| US | 2011 Nov. 10 | HILLIS; W. | A perpetual motion device derived from |
| 20110273968 | | Daniel | a pendulum that releases an object mid- |
| A1 | | KHANLIAN; | swing, generating additional force that |
| | | Luke Walter | allows it to return to its original state. |
| US | 2010 Sep. 23 | Yu; Howard | A pendulum with a double bar that |
| 20100237631 | | | rotates on a semicircular circuit, driving |
| A1 | | | a perpetual motion that generates |
| | | | electricity. |
| US | 2010 Jun. 17 | Duclos; Paul | A pendulum linked to a wheel that, |
| 20100148517 | | | through oscillation, generates torque to |
| A1 | | | the pendulum axis, which generates |
| | | | electricity. |
| US | 2008 Jan. 3 | Claypool; | A pendulum mounted on a mobile axis |
| 20080001579 | | Kenneth | that generates greater force in the fall of |
| A1 | | | the pendulum that generates a rotation |
| | | | of the axis and generation of electricity. |
| US | 2007 Jun. 21 | Duclos; Paul | A pendulum with a solenoid that takes |
| 20070137943 | | | advantage of the oscillation to generate |
| A1 | | | energy. |
| US | 2007 Jan. 18 | Gomez-Nacer; | A system of pendulums linked to a |
| 20070012518 | | Maximo | generator to drive the oscillation, which |
| A1 | | | in turn generates electricity. |
| US | 2005 Nov. 10 | Seoane, | A pendulum with an axis on a wheel |
| 20050248159 | | Diego Luis | that rotates to drive the pendulum, and |
| A1 | | Felipe | transforms the rotating energy of the |
| | | Bernardo | wheel to generate electricity. |
| | | Castanon | |

### Applicable U.S. Patent Classification Definitions

CLASS 60—POWER PLANTS: Residual class concerned with the driving of a load by the conversion of heat, pressure, radiant, or gravitational energy into mechanical motion.

Subclass 371—Having means to store and release energy usable to energize motor work output means: Apparatus comprising means to store some of the energy available to activate or output from the motor means during part of the time while the motor working member is in motion whereby said stored energy may be released to motivate the working member during another part of the time when it is in motion.

Subclass 372—Pneumatic counter-balance of gravity load on motor (e.g., deep well pump rod, etc.). Apparatus wherein the energy resulting from the gravitational force on the load is stored during a part of the cycle of operation of the motor means for release to aid in the activation of the working member during another part of the cycle of operation of the motor.

Lines with Other Classes:

CLASS 74—MACHINE ELEMENT OR MECHANISM: Mechanical

combinations, contrivances, or devices constituting portions of machines, instruments and apparatus and consisting of two or more fixed and movable parts so combined that the motion of one compels a completely controlled or constrained motion of the other according to a law of operation inherent in and depending on the nature of the combination, and also the elemental parts of such machines not provided for in other machine element classes.

CLASS 185—MOTORS: Motors: Spring, Weight, or Animal Powered, appropriate subclass for a spring, weight or animal powered motor and for plural or composite motor combinations consisting solely of arrangements of such motors.

CLASS 290—PRIME-MOVER DYNAMO PLANTS: This class includes patents for the production and transmission of electric power and does not include any specific use to which the power is put.

This is the residual class for all subject matter, not elsewhere classified, relating to electrical generator or motor structure.

CLASS 310—ELECTRICAL GENERATOR OR MOTOR STRUCTURE: This is the residual class for all subject matter, not elsewhere classified, relating to electrical generator or motor structure.

CLASS 322—ELECTRICITY: SINGLE GENERATOR SYSTEMS: This is the Generic Class for: Single electric energy generators for supplying single load circuits.

### BRIEF SUMMARY OF THE INVENTION

This invention is an apparatus intended for harnessing the gravitational force in order to produce electric power. It uses the kinetic energy produced by a system of three double pendulums, arranged and synchronized in such way that, when oscillating, produce a torque that is transmitted by a couple of gear boxes, to a stator inside a power generator that, when rotating, produces an electric current.

The oscillation of each of the three double pendulums is controlled by a mechanism that restricts the otherwise random motion to a specific path, which is designed to optimize the amount of kinetic energy that is produced. This kinetic energy is such that allows the double pendulum to return to its original position while producing excess energy that is harnessed and transformed into torque in a drive shaft. The speed at which the double pendulum system rotates is designed to be of between 25 and 35 revolutions per minute (rpm).

The torque of the drive shaft is then transmitted to a couple of gear boxes. In the second one, a low-speed gear is engaged by the drive shaft, making it rotate at the speed in which the system of double pendulums is turning. This gear engages a medium-speed gear, that multiplies the rpm by a factor of 10×. This gear, in turn, engages a high-speed gear that, again, multiplies the rpm by a factor of 10×. Therefore, the rpm at which the drive shaft enters the gearbox is of between 25 and 35 rpm, whereas the drive shaft that exits the gear box revolves at a rate of between 2,500 and 3,500 rpm.

Finally, the drive shaft, enters the power generator, and it engages a stator that rotates and produces an electric current. The amount of electricity that is produced is proportional to the force (torque) and speed at which the stator is turning.

### BRIEF DESCRIPTION OF VIEWS OF THE DRAWING

FIG. 1|5. General diagram:

This figure depicts an abstraction of the entire electrical energy generation apparatus based on the principles of the double pendulum. The top section shows the three-double pendulum system in which each of them is in a different moment of their oscillatory movement, as to show how they would swing around the drive shaft. This drive shaft enters a box, where a bevel gear is located in order to transmit the torque of the horizontal drive shaft to a vertical drive shaft, which exits the box by its bottom side. Then, this vertical drive shaft enters a second box, located on the bottom section of the drawing. Inside the box, there is a second bevel gear which transmits the torque from the vertical drive shaft to a horizontal drive shaft that activates the low- to medium- to high-speed gears. After engaging these gears, a third and final horizontal drive shaft exits the box on its left side and enters a power generator. Finally, the drive shaft turns a rotor attached to a stator which, by turning, produces the electrical current.

FIG. 2|5. Hub for gearing cassette and ratchet:

This figure depicts an abstraction of the inside of a hub where a gearing cassette and ratchet are located. This hub is the fixed point where each of the double pendulums is suspended. The gearing cassette and ratchet is the mechanism by which the drive shaft is turned, producing a torque, when the double pendulum performs its oscillatory motion. This mechanism is homologous to the one used on bicycles to engage and release the freehub when pedaling. As such, when the double pendulum reaches certain speed and force during the swing, it engages the ratchet producing a torque. The rest of the time, when the swinging speed and the force do not cross the pre-determined threshold, the ratchet is not engaged, thus maintaining its free rotation.

FIG. 3|5. Swing control gear:

This figure shows the mechanism that is used to attach the first and the second pendulums, and it is located on the extreme of the first one. The function of this gear is to control the way in which the second pendulum performs its oscillatory motion. This mechanism is necessary since the theoretical motion of a double pendulum follows a random oscillatory path. Therefore, the swing control gear takes away the theoretical randomness, in order to produce the motion that is required to attain the maximum amount of speed and energy in a pre-determined pattern in each set of revolutions, which also allows to perform a synchronized motion between each of the three double pendulums of the system.

FIG. 4|5. Bevel gear box:

This figure shows the gear box which serves to transmit the torque from a horizontal drive shaft, which enters the gear box on its left side, to a vertical drive shaft, which exits the gear box on its bottom side, by means of using a bevel gear.

FIG. 5|5. Low- to high-speed gear box:

This figure shows two different sets of gears. The first one is a bevel gear which, similar to FIG. 4|5, is used to transmit the torque from the vertical drive shaft that enters the gear box on its top side, to a horizontal drive shaft, by means of using a bevel gear. Once the torque is transmitted to the horizontal drive shaft, it engages the low-speed gear, which is a proportionally larger gear that turns at the rate of the double pendulum system (between 25 and 35 revolutions per minute-rpm-). This low-speed gear then engages a proportionally smaller gear, called medium-speed gear that increases the rotation speed by a factor of 10×, which means that it revolves at a rate of between 250 and 350 rpm. Finally, this gear engages a high-speed gear, which is the smallest of all three gears which, in turn, increases the rotation speed by a factor of 10×, reaching a revolving rate of between 2,500 and 3,500 rpm. The high-speed gear engages the horizontal drive shaft that exits the gear box on its right side, and such shaft then enters the power generator to transmit the torque to the stator that produces the electrical current.

### DETAILED DESCRIPTION OF THE INVENTION

This invention is an apparatus intended for harnessing the gravitational force in order to produce electric energy. It relies on the oscillation of several controlled and synchronized double pendulums. A double pendulum is a system of two pendulums where the second is suspended from the end of the first pendulum.

To our best knowledge, this energy source has not been developed and remains a potential source, rather than an actual source. This invention addresses several of the shortcomings mentioned in the “Background of the invention” section. Firstly, gravitational force is universally available, stable, and does not depend on external conditions, thus eliminating the main shortcomings of sun, wind, and marine energy. Secondly, this invention is highly versatile, in the sense that it can be used for energy solutions at home-scale, but also for residential or commercial buildings, for industrial facilities, or for utilities for mass electricity production and distribution. On all cases, the physical space that is required for the installment of this technology is substantially lower than any other of the green technologies, and it does not require specific geographic or weather conditions, thus having the potential for being installed virtually in any place. These characteristics would allow for a wider and cheaper access to electric energy, interconnected or not to the grid. It would also produce a more flexible and robust system, dependent on a distributed generation network, that reduces the overall risk of the grid. Finally, this invention is emissions free, and does not require rare, expensive or unavailable minerals for its production, thus it would reduce the pressure over mining operations, extensive use of land, and the related conflicts.

A regular pendulum, when released from its upmost vertical position, is affected by two forces: Gravity force that pulls the point mass (pendulum bob) downwards, and tension force that pulls the point mass towards its pivot. Due to these opposed forces, a pendulum is unable to return to its original position, and will oscillate until reaching a motionless equilibrium. On its part, a double pendulum performs two independent oscillatory motions that occur at the same time and, when they follow specific paths, the point mass is able to produce a substantially larger amount of kinetic energy. Nonetheless, the oscillatory motion of a double pendulum is chaotic, in the sense that each oscillation follows a random path.

This invention takes advantage of these principles; however, it takes away the randomness of the motion of the double pendulum by using a swing control mechanism, that produces a specific oscillatory movement that optimizes the amount of kinetic energy produced by the whiplash-like motion of the point mass. The kinetic energy produced by the controlled motion is such that allows the double pendulum to return to its original vertical position while channeling the excess kinetic energy to a mechanism that recovers it and transforms it into a torque that is applied to a drive shaft.

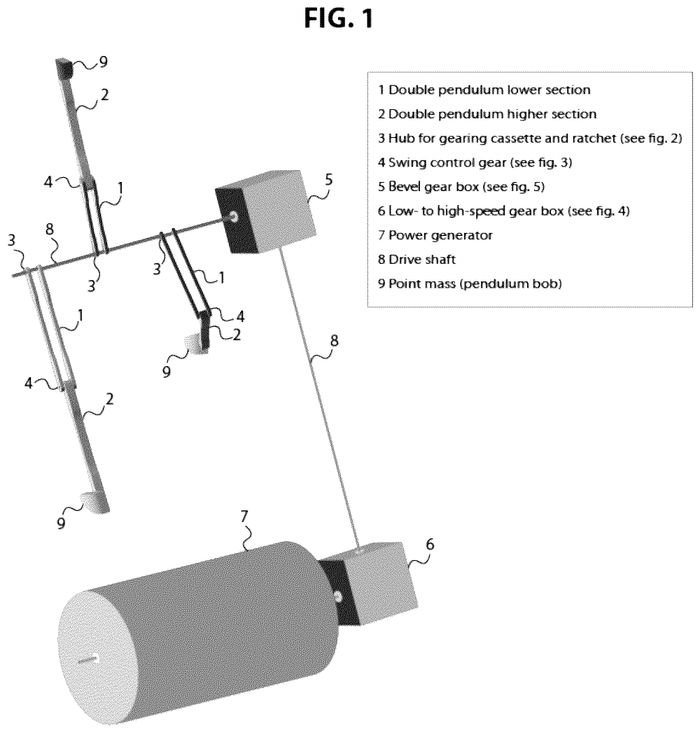

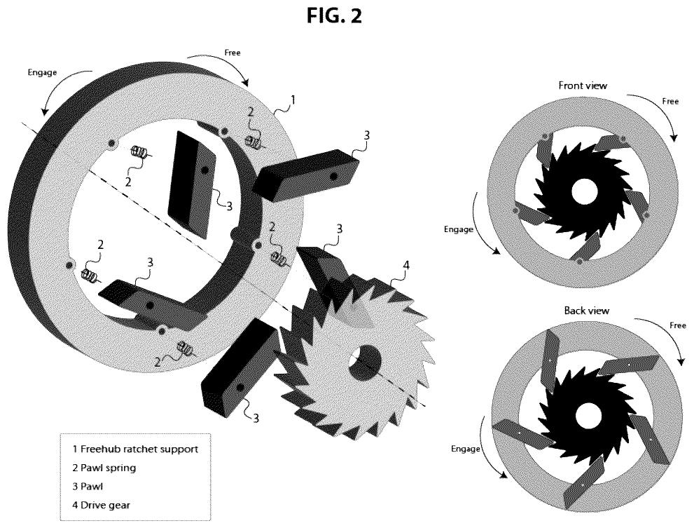

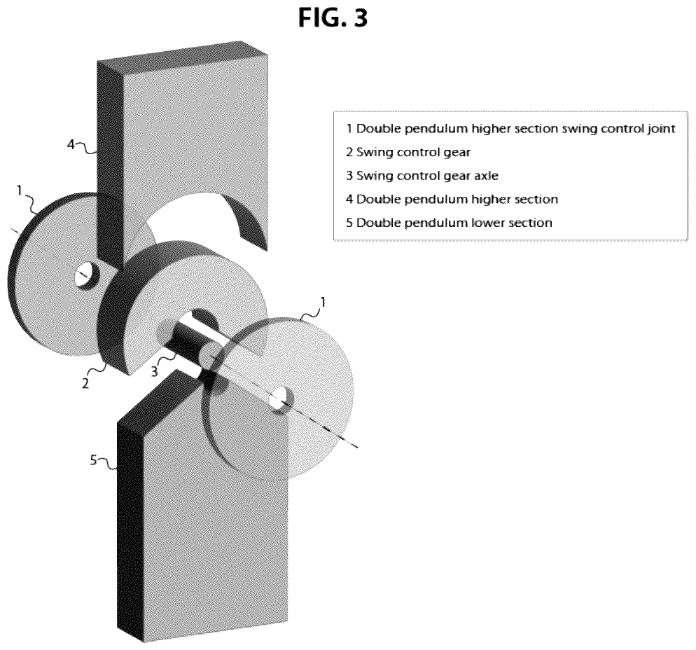

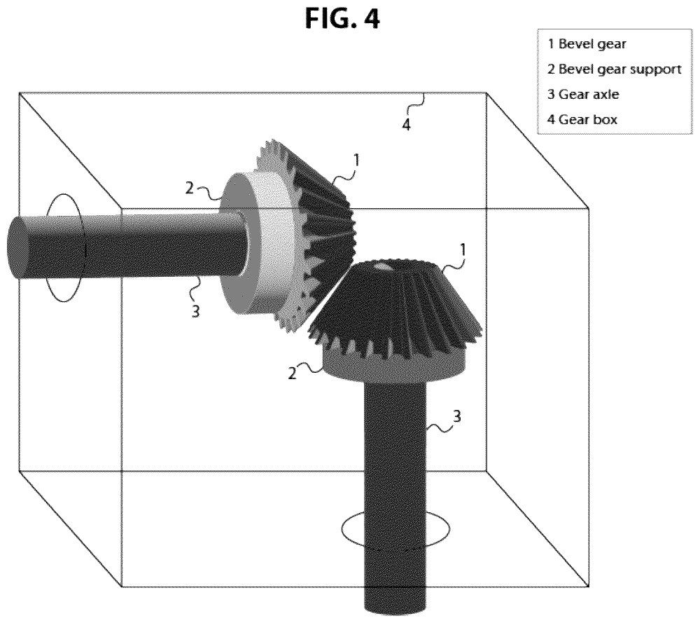

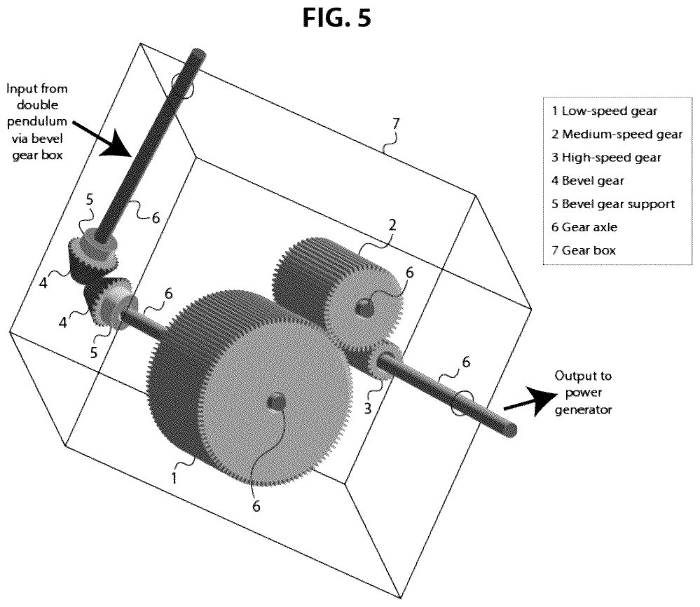

The general idea, which is shown in FIG. 1|5, is the following:

A system of three synchronized double pendulums, that can be arranged in one or several series (each series composed by one three-double pendulums system); is mounted over a drive shaft. Each double pendulum performs a set of oscillatory movements, falling downwards from its upmost vertical position in a synchronized manner, in such way that the point mass located in the extreme of the second pendulum, accelerates because of the gravitational force, and produces kinetic energy as it falls. Two swing control gears control the path in which the oscillatory movements occur, allowing the double pendulum to perform a set of oscillations until reaching the maximum amount of kinetic energy that the point mass can produce in a whiplash-kind of movement.

The resulting kinetic energy will depend on three factors: The weight of the point mass, the length of each of the two sections (arms) of the double pendulum, and the path that the oscillatory movement follows. Regarding the latter factor, the swing control gears are critical for this invention, since the oscillatory motion of a theoretical double pendulum is chaotic, i.e., the path that it follows is random. Therefore, attaining a specific path for the oscillatory movements that optimizes the amount of kinetic energy that can be produced, will be determined by the swing control gears.

As mentioned above, each of the two pendulums is controlled at their corresponding fixed points by a swing control gear. The fixed point of the first pendulum which is attached to the drive shaft, is a hub with a gearing cassette and a ratchet (see FIG. 2|5). The second pendulum is attached by a swing control gear located at the extreme of the first pendulum (see FIG. 3|5). These gears serve to control the form in which the oscillatory motion takes place, thus allowing for a pre-determined set of swings that produce the maximum possible amount of kinetic energy.

The goal of attaining such maximum possible amount of kinetic energy serves two purposes. The first one is to produce sufficient energy as for the double pendulum to complete its set of revolutions and return to its original position on top of the drive shaft. The second is that, since the energy produced is higher than what is required to complete its set of revolutions, the excess energy is then used to generate a rotational torque that is transmitted through the drive shaft and, after some transformations, reaches the energy generator.

The way for transforming the kinetic energy into rotational torque of the drive shaft is through a hub that contains a gearing cassette and a ratchet, that serves as fixed point for the first pendulum (see FIG. 2|5). These gears are engaged when the double pendulum reaches certain speed and energy, in the bottom section of its oscillating motion. The rest of the time, the ratchet is not engaged, thus allowing for a free swing of the double pendulum. The mechanism is homologous to the one used on bicycles to engage and release the freehub when pedaling.

The system of three double pendulums, works in the following way. The double pendulum one is released to perform its set of oscillatory movements, and when it reaches one third of its path, the double pendulum two is released and, finally, when the double pendulum two reaches one third of its path, the double pendulum three is released. As the double pendulum one reaches the desired amount of kinetic energy, it engages the hub that contains the gearing cassette and the ratchet, producing a rotational torque on the drive shaft. As the kinetic energy is channeled to produce the torque over the drive shaft, the double pendulum loses speed and energy, and the hub is disengaged, thus freeing the double pendulum swing and allowing it to continue on its motion until reaching its original position. Once the double pendulum one disengages the ratchet, the double pendulum two enters its engaging period on the hub, providing continuity for the rotational torque on the drive shaft. As the double pendulum two disengages the hub, the double pendulum three enters its engaging period, in the same way of the other two, thus maintaining a stable torque on the drive shaft. Finally, when the double pendulum three disengages the hub and starts its free motion towards its original position, the double pendulum one has already started again its motion, to enter its engaging period right after the double pendulum three disengages the hub, and so on. This continuous motion allows for the drive shaft to maintain a stable rotational torque.

If necessary, in order to produce additional torque for a larger generator; it is possible to include additional double-pendulum systems, which work in the same way as was explained above. The double pendulum one of each of the additional systems is released simultaneously with the double pendulum one of the first system, thus multiplying the force that is generated by the number of additional systems that are included in the mechanism. Additionally, depending on the user's needs, the weight of the point mass and length of both arms of the double pendulum arms can be adjusted to produce the energy that is required. This makes the apparatus very versatile, allowing different scales and configurations for power generation, such as for single-family homes, residential or commercial buildings, industrial facilities or commercial mass generation.

The rotational torque that is produced as explained above, goes through a bevel gear box that transmits the torque from a horizontal to a vertical drive shaft (see FIG. 4|5). In its turn, this vertical drive shaft enters a low- to high-speed gear box (see FIG. 5|5). In this low- to high-speed gear box, the vertical shaft engages a bevel gear, transmitting the torque from the vertical to a horizontal drive shaft. The horizontal drive shaft rotates a low-speed gear, which is the largest gear of the box. This gear rotates at the same rate as the drive shaft, which is designed to be of between 25 and 35 revolutions per minute (rpm). The low-speed gear engages a medium-speed gear, which multiplies the rotational speed by a factor of 10, reaching between 250 and 350 rpm. In its turn, the medium-speed gear engages a high-speed gear, which is the smallest of the three gears. This gearbox multiplies the rotational speed of the drive shaft by a factor of 10, reaching 2,500 to 3,500 rpm.

Finally, the high-speed gear transmits the torque to the drive shaft that enters the electric generator. Specifically, the drive shaft makes the stator rotate at the same rate of between 2,500 and 3,500 rpm, thus producing the electrical current. It is important to consider that the size, weight and energy production capacity are proportional to the double pendulum system capacity for producing a rotational torque.

1. An apparatus for generating electric power by harnessing the gravitational force, comprising:
a system of double pendulums;
a swing control gear; and
a gearing cassette and ratchet.

2. A device according to claim 1, characterized in that, the gearing cassette and ratchet is a mechanism from which pendulum one is suspended.

3. A device according to claim 1, characterized in that, the swing control gear is a mechanism at the extreme of the pendulum one, from which pendulum two is suspended.
